(19) United States
(12) Patent Application Publication
(10) Pub. No.: US 2017/0143573 A1
(43) Pub. Date: May 25, 2017

(54) EXOSKELETON COMPRISING A FOOT STRUCTURE

(71) Applicant: WANDERCRAFT, ORSAY (FR)

(72) Inventor: Alexandre BOULANGER, ORSAY (FR)

(21) Appl. No.: 15/127,769

(22) PCT Filed: Mar. 23, 2015
(86) PCT No.: PCT/EP2015/056150

§ 371 Date: Sep. 20, 2016

(30) Foreign Application Priority Data
Mar. 21, 2014 (FR) 1452370
Mar. 21, 2014 (FR) 1452372

(51) Int. Cl. A61H 3/00; A61H 1/02; B25J 9/00

(52) U.S. Cl. CPC A61H 3/00; B25J 9/0006; A61H 1/0262; A61H 1/0266; G05B 2219/40305; A61H 2201/1215; A61H 2201/1246; A61H 2201/149; A61H 2201/1628; A61H 2201/164; A61H 2201/165; A61H 2201/5035; A61H 2201/5084

(57) ABSTRACT

The invention relates to an exoskeleton in which a foot structure (308) includes a supporting plane (310) on which the foot of a person wearing the exoskeleton can rest when the foot is flat. The supporting plane comprises a front platform (903) and a rear platform (904). A foot pivot link (905) connects the front platform to the rear platform.

### TECHNICAL FIELD

An aspect of the invention relates to an exoskeleton comprising a foot structure.

### PRIOR ART

Patent publication WO 2011/002306 describes a control system for controlling an exoskeleton worn by a user and comprising one or more actuators associated with various body members of the exoskeleton, each corresponding to a part of the body of the user.

The exoskeleton comprises a foot structure to be fixed on a foot of a user. The foot structure is pivotally connected to an end of a lower element of a leg structure. A shoe in which the user can place his foot is releasably engaged with the foot structure.

### EXPLANATION OF THE INVENTION

There is a need for a solution for making exoskeletons reproducing a function of human walking, which is relatively faithful and energetically efficacious.

According to a first aspect of the invention, an exoskeleton comprises:
a foot structure comprising a support plane on which a foot of a person wearing the exoskeleton can be supported when the foot lays flat, the support plane comprising:
a front platform and a rear platform, and
a foot pivot link connecting the front platform to the rear platform.

In such an exoskeleton the foot pivot link constitutes a break in the support plane allowing more fluid walking movement, less jerky, more natural and more rapid relative to a support plane in a single part, without a break, such as proposed in the above patent publication. During a walking process, a support plane in a single part, without a break, should leave the ground either parallel to this ground, or by terminating by one-off or linear support difficult to control. The foot pivot link overcomes these restrictions and contributes therefore to more closely reproducing a walking function which the person wearing the exoskeleton has lost. This contributes also to easier acceptance of the exoskeleton by the person wearing it, as well as easier and faster accommodation.

Another advantage of the foot pivot link consists of a forward propulsion effect when the rear platform comes off the ground, while the front platform continues to be supported on the ground. The break, formed by the foot pivot link, constitutes an axis of rotation for a controlled falling motion. This axis of rotation adds a forward translation component to the controlled falling motion. This forwards propulsion effect is important in dynamic walking of a human being. The effect lengthens a step in an energetically efficient way.

An embodiment of the invention can comprise one or more of the additional following characteristics such as defined in the following paragraphs.

The foot pivot link can comprise an elastically deformable member disposed to store energy when the front platform is folded relative to the rear platform. The elastically deformable member recovers some of the potential energy released during a phase in a walking process which is characterized by a controlled forwards fall. The elastically deformable member stores this energy to restore it in another phase, for example, when the foot structure comes off the ground on completion of a step.

The support plane of the foot structure can comprise a flexible sole adapted to contact the ground.

The support plane of the foot structure can comprise a surface adapted to contact the ground whereof at least one part is delimited by a rounded edge. Such a rounded edge fluidifies forward movement even more. Rounds on the sides of the sole let the foot roll slightly on its sides, especially when lateral pulses are produced at the pelvis so as to balance out a lateral parasite movement, especially in upright position when stopped.

The foot pivot link can be located in a quadrant delimited by a median sagittal section of the person wearing the exoskeleton and a frontal section passing through the leg, the foot pivot link having a pivot axis defining a right triangle in this same quadrant and having an angle in a range from 45° to 90° relative to the median sagittal section, preferably between 50° and 85°, for example between 60° and 65°, typically of the order of 63°.

The rear platform can be closer to the median sagittal section than the front platform, such that the median longitudinal axis of the support plane exhibits an angle of between 0° and 45° relative to the median sagittal section when the exoskeleton is in rest position, preferably between 5° and 35°, for example between 15° and 20°. This orientation towards the exterior best reproduces a human walking since human feet are also oriented this way. Also, when a step is taken, during a thrust phase, this orientation best directs the thrust. The thrust thus comprises a latero-medial component for propelling the body of the person wearing the exoskeleton from one support foot to a receiving foot.

According to a second aspect, the exoskeleton can comprise a leg structure disposed to be next to the leg of the person wearing the exoskeleton. An ankle pivot link can connect the foot structure to the leg structure. The ankle pivot link can have a pivot axis having:
a non-zero angle in a range from 0° to 30° relative to the support plane of the foot structure, preferably between 5° and 30°, and
a non-zero angle in a range from 0° to 45° relative to a plane perpendicular to the median longitudinal axis of the support plane.

In such an exoskeleton, the pivot axis of the ankle pivot link has a particular orientation: the pivot axis is not contained in any reference plane: frontal, sagittal or horizontal. This particular pivot axis, which is oblique, lets the exoskeleton produce movements at an ankle, which are similar to natural movements, especially those which are the most frequent and biggest at this level. A single pivot link and a single actuator are therefore enough at the ankle. By way of contrast the exoskeleton presented in the above patent publication comprises two pivot links and two actuators to produce movements at an ankle. The exoskeleton according to the invention can therefore have a simpler, lighter, less bulky, and less energy-intensive structure.

According to a preferred, though non-limiting characteristic, the exoskeleton can further comprise an actuation device disposed between the leg structure and the foot structure to cause pivoting of the foot structure relative to the leg structure along the pivot axis of the ankle pivot link.

Optionally, the actuation device comprises:
a Cardan joint, a ball-joint link, and an actuator disposed between the Cardan joint and the ball-joint link, or
two Cardan joints and an actuator without anti-rotation disposed between the Cardan joints, typically a linear actuator.

These elements enable a kinematic loop which can describe movements in three dimensions. During these movements the actuator remains along a lower segment of the leg structure. This allows minimal bulk of this assembly and avoids interferences between the actuator and the relevant leg of the person wearing the exoskeleton.

The leg structure can comprise an upper leg segment disposed to be next to an upper part of the leg located above a knee of the person wearing the exoskeleton, a lower leg segment disposed to be next to a lower part of the leg located below the knee, and a knee pivot link connecting the lower leg segment to the upper leg segment. The upper leg segment can have a non-zero inclination in a range from 0° to 30° relative to the lower leg segment when the exoskeleton is in rest position, preferably from 0° to 20°, such that an upper end of the upper leg segment is further away from a median sagittal section of the person wearing the exoskeleton than a lower end. This inclination lets the exoskeleton perform weight transfer to a foot more quickly and more economically in energy, relative to a structure without such an inclination. The inclination reduces displacement of the centre of gravity which is necessary for the latter to be located above a support foot.

The exoskeleton can comprise a pelvic structure disposed to be attached to the pelvis of the person wearing the exoskeleton, a leg orientation pivot link disposed between the pelvic structure and the leg structure, the leg orientation pivot link having a vertical pivot axis when the exoskeleton is in rest position. This lets a leg perform vertical rotations which can occur in a stabilization process and in a walking process. These vertical rotations contribute to these processes being efficacious and perceived as being natural by the person wearing the exoskeleton.

The exoskeleton can comprise a control device capable of controlling at least one actuator included in the exoskeleton.

The control device can comprise a detector capable of detecting at least one dynamic parameter of at least one part of the torso of the person wearing the exoskeleton, and a processor capable of applying a control signal to an actuator as a function of a detected parameter. This permits an intuitive command of the exoskeleton: the command is forgotten, the exoskeleton can be used naturally. It should be noted that this aspect does not depend on the aspects described hereinabove. For example, the aspect of the command can be implemented without the exoskeleton comprising an ankle pivot link such as defined hereinabove, characterized by an oblique pivot axis.

The detector can comprise at least one inertial sensor.

The processor can be configured to perform several control modes, including: a stabilization control mode in which the processor controls at least one actuator to keep the person wearing the exoskeleton in a rest position, and a walking control mode in which the processor controls at least one actuator to assist the person wearing the exoskeleton to walk.

The processor can be configured to determine a position of a centre of gravity of at least one body part of the person wearing the exoskeleton and apply a control mode as a function of the position of the centre of gravity.

The processor can be configured to combine different controls modes respectively with different zones in a plane on which the centre of gravity is projected, the processor thus can apply a control mode associated with a zone containing the centre of gravity.

By way of illustration, a detailed description of a few embodiments of the invention is presented hereinbelow in reference to appended drawings.

### SUMMARY DESCRIPTION OF THE DRAWINGS

FIG. 1 is a schematic front view of a person able to wear an exoskeleton.

FIG. 2 is a schematic side view of the person.

FIG. 3 is a perspective view of a part of an exoskeleton comprising lower members.

FIG. 4 is a rear view of a pelvic structure of the exoskeleton.

FIG. 5 is a schematic diagram of the exoskeleton in a state of rest.

FIG. 6 is a schematic diagram of the exoskeleton in a state actuated at the pelvic structure.

FIG. 7 is a schematic diagram of the exoskeleton in another state actuated at the pelvic structure.

FIG. 8 is a simplified schematic diagram of the exoskeleton in the state of rest.

FIG. 9 is a top plan view of two foot structures of the exoskeleton.

FIG. 10 is a bottom plan view of a support plane of a left foot structure of the exoskeleton.

FIG. 11 is a simplified schematic diagram of the left foot structure.

FIG. 12 is a perspective view of a left lower part of the exoskeleton comprising an ankle pivot link.

FIG. 13 is a schematic diagram representing a pivot axis of the ankle pivot link.

FIG. 14 is a schematic diagram representing a projection plane for a control mode selection.

### DETAILED DESCRIPTION

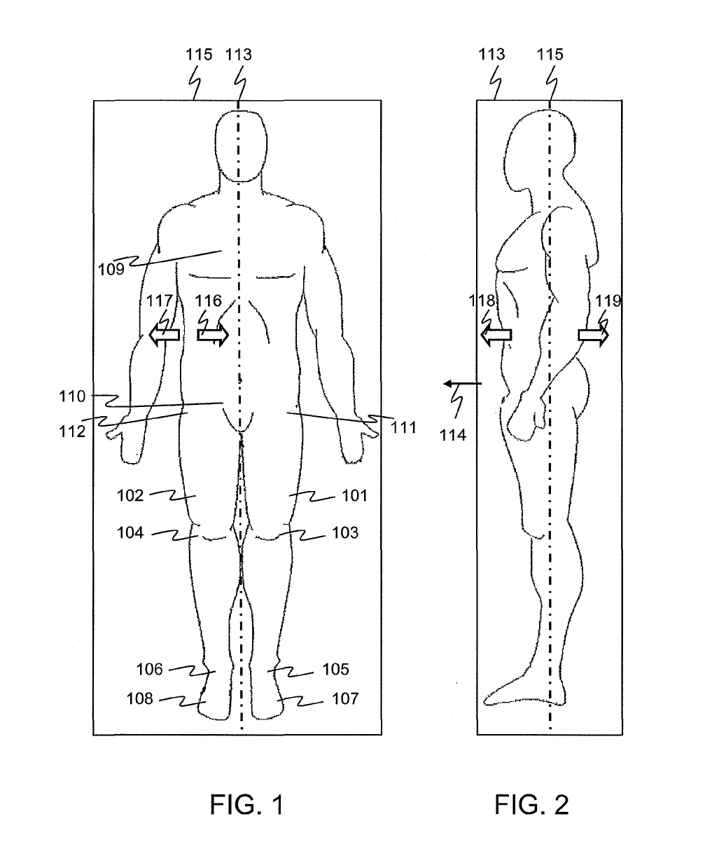

FIGS. 1 and 2 illustrate a person who can wear an exoskeleton 300. FIG. 1 offers a schematic front view of the person. FIG. 2 offers a schematic side view of the person. The person has two legs, a left leg 101 and a right leg 102, with respectively a left knee 103 and a right knee 104. The person has two ankles, a left ankle 105 and a right ankle 106, and two feet, a left foot 107 and a right foot 108. The person also has a torso 109, a pelvis 110, hips 111, 112 and kidneys, the latter organs not being shown in FIGS. 1 and 2 for reasons of simplicity and convenience.

FIGS. 1 and 2 also illustrate a median sagittal section 113 of the person.

This section comprises an axis 114 corresponding to a direction in which the person could typically walk. This axis will be called “direction of step” hereinbelow. FIGS. 1 and 2 further illustrate a frontal section 115 passing through the two legs 101, 102. FIG. 1 illustrates two orientations: medial 116 (towards 113) and lateral 117 (opposite 115). FIG. 2 illustrates two other orientations: anterior 118 (or front) and posterior 119 (or rear).

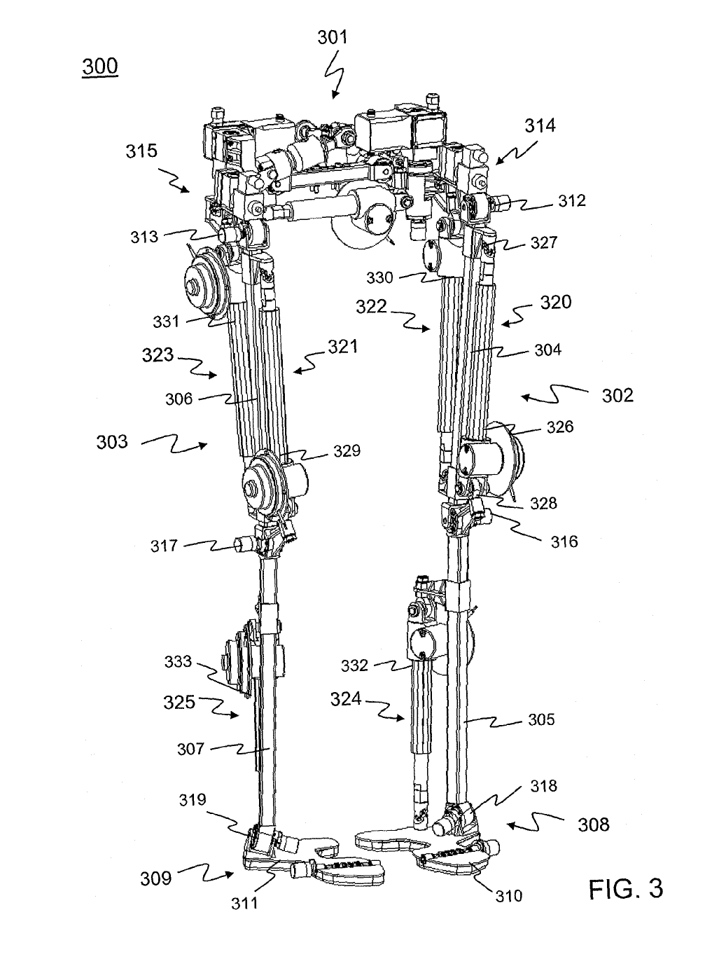

FIG. 3 illustrates an exoskeleton 300 which the person illustrated in FIGS. 1 and 2 can wear. FIG. 3 offers a perspective view of the exoskeleton 300. The exoskeleton 300 comprises a pelvic structure 301 which is located behind the kidneys of the person when he is wearing the exoskeleton 300. The pelvic structure 301 can be attached to the pelvis 110 illustrated in FIG. 1. This attachment can be flexible by means of, for example, a harness or one or more straps, or a combination of such elements. These elements are not shown in FIG. 3 for reasons of simplicity and convenience.

The exoskeleton 300 further comprises two leg structures: a left leg structure 302 and a right leg structure 303. The left leg structure 302 is disposed to be next to the left leg 101 of the person illustrated in FIGS. 1 and 2. The right leg structure 303 is disposed to be next to the right leg 102 of this person.

In more detail, the left leg structure 302 comprises an upper leg segment 304 and a lower leg segment 305. The upper leg segment 304 is disposed to be next to an upper part of the left leg 101 located above the left knee 103 of the person illustrated in FIGS. 1 and 2. The lower leg segment 305 is disposed to be next to a lower part of the left leg 101 located below the left knee 103. Similarly, the right leg structure 303 also comprises an upper leg segment 306 and a lower leg segment 307 illustrated in FIG. 3.

The exoskeleton 300 comprises two foot structures: a left foot structure 308 and a right foot structure 309. The left foot structure 308 comprises a support plane 310 on which the left foot 107 of the person illustrated in FIGS. 1 and 2 can be supported when the left foot 107 lays flat. Similarly, the right foot structure 309 comprises a support plane 311 on which the right foot 108 can be supported when the right foot 108 lays flat.

The exoskeleton 300 comprises two hip structures: a left hip structure 314 disposed to be next to a left hip 111 of the person and a right hip structure 315 disposed to be next to a right hip 112 of the person illustrated in FIGS. 1 and 2.

The exoskeleton 300 comprises several pivot links: a pair at the hips, a pair at the knees, and a pair at the ankles.

In more detail, the pair of pivot links at the hips comprises a left hip pivot link 312 and a right hip pivot link 313. The left hip pivot link 312 rotationally connects the left leg structure 302 to the left hip structure 314. Similarly, the right hip pivot link 313 connects the right leg structure 303 to the right hip structure 315.

The pair of pivot links at the knees comprises a left knee pivot link 316 and a right knee pivot link 317. The left knee pivot link 316 connects the lower leg segment 305 of the left leg structure 302 to the upper leg segment 304 of this structure. Similarly, the right knee pivot link 317 connects the lower leg segment 307 of the right leg structure 303 to the upper leg segment 306 of this structure.

The pair of ankle pivot links comprises a left ankle pivot link 318 and a right ankle pivot link 319. The left ankle pivot link 318 connects the left foot structure 308 to the left leg structure 302. Similarly, the right ankle pivot link 319 connects the right foot structure 309 to the right leg structure 303.

The exoskeleton 300 comprises more pivot links. These other pivot links will be presented and described hereinbelow.

The exoskeleton 300 comprises several actuation devices 320-325. One actuation device is associated with a pivot link mentioned hereinabove. The actuation device lets the elements connected by the pivot link in question make a rotation movement one relative to the other. In this way, the exoskeleton 300 comprises a left knee actuation device 320, a right knee actuation device 321, a left hip actuation device 322, a right hip actuation device 323, a left ankle actuation device 324, and a right ankle actuation device 325.

The left knee actuation device 320, which is associated with the left knee pivot link 316, is described in more detail by way of example. The left knee actuation device 320 comprises an actuator 326 and two rotary connecting members 327, 328. One rotary connecting member 327 connects an end of the actuator 326 to the upper leg segment 304 at a connection point relatively far away from the left knee pivot link 316. The other rotary connecting member 328 connects another end of the actuator 326 to the lower leg segment 305 at a connection point relatively close to the left knee pivot link 316, just below the latter.

The actuator 326 is capable of describing a linear movement between its ends. This linear movement is transformed into a rotation movement of the lower leg segment 305 relative to the upper leg segment 304. The rotary connecting member 327 can comprise a Cardan joint. The other rotary connecting member 328 can comprise a ball-joint. FIG. 3 illustrates this arrangement, which can be also reversed. Such an arrangement lets the left knee actuation device 320, and the leg segments, upper 304 and lower 305, describe useful movements, in three dimensions. The connection points, mentioned hereinabove, remain fixed respectively relative to the upper leg segment 304 and relative to the lower leg segment 305.

The actuation device 320 associated with the left knee pivot link 316 constitutes in fact a quadrilateral having a segment of variable length. This segment is the actuator 326 which can be in the form of a jack. This jack can be, for example, an electric, hydraulic, pneumatic jack or any other type of linear actuator. The jack has a length adjustable by means of a control signal applied to the jack. The actuator 326 associated with the left knee pivot link 316 will be designated by “left knee actuator 326” hereinbelow for reasons of clarity and convenience.

The other actuation devices 321-325 mentioned hereinabove have a similar structure and therefore function similarly. These actuation devices also comprise actuators 329-333 shown in FIG. 3. These actuators will be respectively designated by “right knee actuator 329”, “left hip actuator 330”, “right hip actuator 331”, “left ankle actuator 332”, and “right ankle actuator 333” hereinbelow for reasons of clarity and convenience. The adjective of such a designation indicates the pivot link with which the actuator is associated.

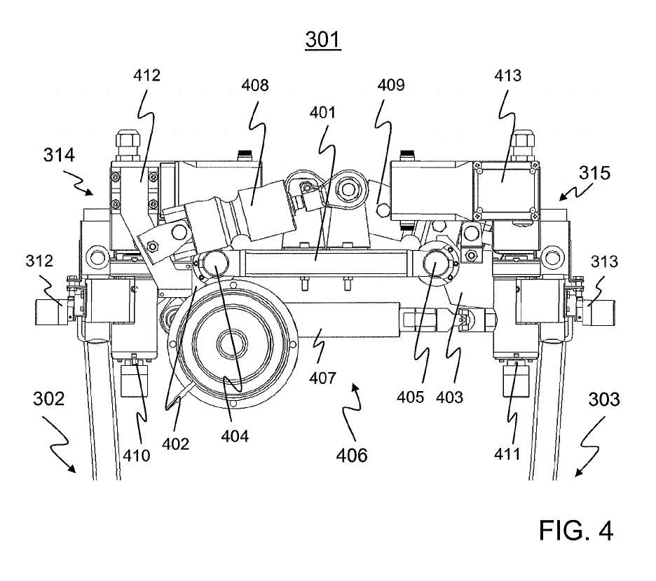

FIG. 4 illustrates the pelvic structure 301 of the exoskeleton 300 in more detail. This figure offers a rear view of the pelvic structure 301. The pelvic structure 301 comprises a central pelvic segment 401 disposed to be attached to the pelvis 110 of the person illustrated in FIGS. 1 and 2. The central pelvic segment 401 can therefore comprise one or more fastening members, such as a harness or one or more straps, as has been mentioned hereinabove.

The pelvic structure 301 comprises a pair of peripheral pelvic segments: a left peripheral pelvic segment 402, and a right peripheral pelvic segment 403.

The pelvic structure 301 comprises a pair of pivot links: a left pelvic pivot link 404 and a right pelvic pivot link 405. The left pelvic pivot link 404 connects the left peripheral pelvic segment 402 to the central pelvic segment 401. The right pelvic pivot link 405 connects the right peripheral pelvic segment 403 to the central pelvic segment 401. These, left 404 and right 405, each present a horizontal pivot axis when the exoskeleton 300 is in rest position.

The pelvic structure 301 further comprises a pair of leg orientation pivot links: a left leg orientation pivot link 410 and a right leg orientation pivot link 411.

The left leg orientation pivot link 410 connects the left peripheral pelvic segment 402 to the left hip structure 314. The right leg orientation pivot link 411 connects the right peripheral pelvic segment 403 to the right hip structure 315. The leg orientation pivot links, left 410 and right 411, present a vertical pivot axis when the exoskeleton 300 is in rest position.

An actuation device 406 is associated with the pair of pelvic pivot links 404, 405. This device comprises an actuator 407 and two articulations. A left articulation connects a left end of the actuator 407 to a connecting rod of the left peripheral pelvic segment 402. A right articulation connects a right end of the actuator 407 to a connecting rod of the right peripheral pelvic segment 403. The actuator 407 can be in the form of a jack. This jack can be, for example, an electric, hydraulic, pneumatic jack or any other type of linear actuator. The actuator will be designated by “pelvic actuator 407” hereinbelow for reasons of clarity and convenience. The pelvic actuator 407 has a length adjustable by means of a control signal applied to the pelvic actuator 407.

A left blockage device 408 is associated with the left pelvic pivot link 404. The left blockage device 408 is switchable between an unlocked state and a locked state. In the unlocked state, the left blockage device 408 enables pivoting of the left peripheral pelvic segment 402 relative to the central pelvic segment 401. This pivoting is possible by way of the left pelvic pivot link 404. But in the locked state, the left blockage device 408 prevents such pivoting. In this state, the left peripheral pelvic segment 402 is rigidly connected to the central pelvic segment 401.

Similarly, a right blockage device 409 is associated with the right pelvic pivot link 405. The right blockage device 409 is also switchable between an unlocked state and a locked state respectively to allow and prevent pivoting of the right peripheral pelvic segment 403 relative to the central pelvic segment 401.

This arrangement of the pelvic structure 301 enables lateral rotation movements at the pelvis 110. Such rotation movement is done either to the left side of the pelvic structure 301 or the right side, at a given instant. This as a function of a blockage respectively of the right pelvic pivot link 405 or the left pelvic pivot link 404. These lateral rotation movements can occur in a stabilization process of the person wearing the exoskeleton when this person is upright and when stopped. This process will be described in more detail hereinbelow.

The lateral rotation movements can also advantageously occur in a walking process: the person wearing the exoskeleton walks in a straight line. These movements are made alternately on the left side and the right side in a way which can be regular, providing left-right pulses at the pelvis 110 during the walking process. These movements contribute to a dynamic equilibrium of forward walking movement. In fact, a walking process is generally characterized by asymmetry of supports on the ground: left foot 107 then right foot 108. The lateral rotation movements, and left-right alternating, contribute to dynamically compensating this asymmetry.

The left pelvic pivot link 404 can comprise an elastically deformable member. The right pelvic pivot link 405 can also comprise an elastically deformable member. These elastically deformable members can comprise, for example, one or more torsion springs. They will be respectively designated by “left pelvic spring” and “right pelvic spring” hereinbelow for reasons of convenience.

The left pelvic spring can store kinetic energy when the left peripheral pelvic segment 402 performs pivoting relative to the central pelvic segment 401 from a rest position. This energy can be reinjected when the left peripheral pelvic segment 402 performs reverse pivoting. This reduces power consumed by the pelvic actuator 407; the left pelvic spring can assist the pelvic actuator 407 to perform reverse pivoting. The same remarks apply to the right pelvic spring which can store kinetic energy when the right peripheral pelvic segment 403 performs pivoting.

The pelvic structure 301 illustrated in FIG. 4 and described hereinabove is particularly adapted to artificial reproduction of the human walking. A subsidence process of the pelvis 110 occurs in human walking, to the side of an oscillating leg taking a forward step. During a forward and propulsion-switching phase, the foot of the other leg, which serves as support, bends and the ankle moves to plantar flexion. Without subsidence of the pelvis 110, the centre of gravity of the human body would tend to rise mechanically, which is superfluous as well as energy consuming.

The pelvic structure 301 is adapted to laterally subside to the side of the oscillating leg. This subsidence can occur by executing masses present from this side. This results in a local fall by gravity, which is controlled by the pelvic structure 301, especially by the pelvic actuator 407. The effect of this is to lower overall elevation of the centre of gravity which might occur without subsidence of the pelvis 110. Also, local fall by gravity releases energy some of which is stored in the pelvic spring in the pelvic pivot link left free.

Then, when the oscillating leg contacts the ground at the end of the step, the side of the pelvic structure 301 which had subsided is raised. The energy stored in the spring can then be contributed. The actuators of the exoskeleton 300 associated with the oscillating leg which has just made contact with the ground, also help to raise the pelvis 110. The pelvic actuator 407, which also comes into play, is therefore not the only one to act. It is enough for the pelvic actuator 407 to provide only some of the energy necessary to raise the pelvic structure 301. The pelvic actuator 407 can be a device having relatively low power and accordingly relatively small dimensions. This enables compact constructions of the pelvic structure 301.

The leg orientation pivot links 410, 411 are actuated. An actuator 412 is associated with the left leg orientation pivot link 410. Similarly, an actuator 413 is associated with the right leg orientation pivot link 411. These actuators 412, 413 can each be in the form of an electrically operated geared motor comprising an electric motor and one or more reduction stages. These reduction stages couple the electric motor to the relevant leg orientation pivot link. The reduction stages can comprise for example one or more gearings, one or more worm and wheel reducers, one or more epicyclic reduction gears and any other type of mechanical reducer. The actuators 412, 413 will be respectively designated “left leg orientation actuator 412” and “right leg orientation actuator 413” hereinbelow for reasons of clarity and convenience.

The left leg orientation pivot link 410 therefore enables motorised vertical rotation of the left leg structure 302 relative to the central pelvic segment 401. Similarly, the right leg orientation pivot link 411 enables motorised vertical rotation of the right leg structure 303 relative to the central pelvic segment 401. These vertical rotations can occur in a stabilization process and in a walking process.

Vertical rotations contribute to these processes being effective and perceived as being natural by the person wearing the exoskeleton.

For example, vertical rotation of the left leg structure 302 appropriately orients the left foot structure 308 to make a turn to the left. Similarly, vertical rotation of the right leg structure 303 can contribute to cornering to the right. In other cases, the leg orientation pivot links 410, 411 have the pelvic structure 301 pivot relative to a leg. This allows weight transfer to the left or to the right. This weight transfer can advantageously intervene to initialize a step movement; the weight is transferred to a support leg. Balancing in upright position also typically involves weight transfer in which the leg orientation pivot links 410, 411 can play a role. The leg orientation pivot links 410, 411 can also intervene in a walking process. Vertical rotation of the pelvic structure 301 relative to a support leg lengthens a step and consequently makes the walking process more effective.

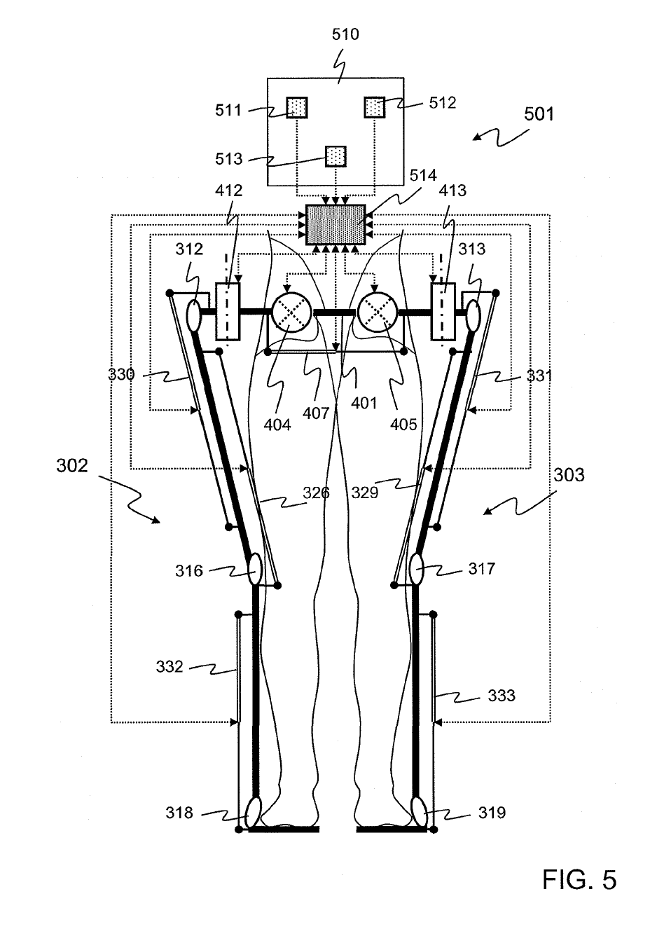

FIG. 5 illustrates the exoskeleton 300 in a state of rest. The exoskeleton 300 is shown via a schematic diagram. Elements identical or similar to those presented hereinabove are marked by identical reference signs.

The exoskeleton 300 comprises a control device 501 capable of controlling various actuators: the pelvic actuator 407, the left leg orientation actuator 412, the right leg orientation actuator 413, the left knee actuator 326, the right knee actuator 329, the left hip actuator 330, the right hip actuator 331, the left ankle actuator 332, and the right ankle actuator 333. The control device 501 can also control the left blockage device 408 and the right blockage device 409, illustrated in FIG. 4, respectively associated with the left pelvic pivot link 404 and with the right pelvic pivot link 405. The control device 501 can control any of the above elements by means of a control signal transmitted to the relevant element. This transmission can be carried out by wire or wirelessly.

The control device 501 comprises a detector 510 capable of detecting a dynamic parameter of a part of the body of the person wearing the exoskeleton. This part of the body is preferably free of the exoskeleton 300, i.e., not connected to the latter. This body part can be for example the torso 109 of the person wearing the exoskeleton illustrated in FIG. 1. In this case the dynamic parameter can comprise a position of the torso 109, a displacement speed of the torso 109, or acceleration of the torso 109.

The detector 510 can comprise an array of inertial sensors 511, 512, 513. For example, two inertial sensors 511, 512 can be located on the chest of the person wearing the exoskeleton. Another inertial sensor 513 can be located at the navel. This site corresponds to a natural centre of gravity for a human. The array of inertial sensors 511, 512, 513 actually defines a triangle. This disposition detects many positions, or many movements, of the torso 109 relative to the legs 101, 102, and therefore relative to the exoskeleton 300. For example, the array of inertial sensors 511, 512, 513 can detect the following positions of the torso 109: leaning to the front, leaning to the rear, leaning to the right side, leaning to the left side. The array of inertial sensors 511, 512, 513 can also detect a state of balance of the pelvis 110 during a walking process, or even rotation of the torso 109.

The control device 501 comprises a processor 514 which receives one or more detection signals of the detector 510. These detection signals indicate a position or a movement of the torso 109. The processor 514 can apply a control signal to one or more of the actuators 407, 412, 413, 326, 329-333 mentioned hereinabove as a function of the position, or movement, of the torso 109 of the person wearing the exoskeleton.

Also, the processor 514 can also receive signals coming from the actuators, giving information on the latter. The processor 514 can take these signals into account to set up control signals. In the process, the processor 514 can execute a control loop for an actuator. The processor 514 can determine a setpoint value for this control loop, and therefore the actuator in question, from the detection signals coming from the detector 510.

More specifically, the processor 514 can add a specific mode of operation of the exoskeleton 300 to a position or a movement of the torso 109. The processor 514 can then generate one or more control signals appropriate for one or more actuators. For example, the processor 514 can interpret the position “leaning to the front” as wanting to move forwards. In this case, the processor 514 controls the actuators of the exoskeleton 300 such that forward movement is effected. This can correspond to a “forward walking” mode of operation. The processor 514 can also employ detection signals to produce balancing of the pelvic structure 301 during this walking. The processor 514 can stabilize the person wearing the exoskeleton in his forward walking and act on the exoskeleton 300 if corrections are necessary. In another example, the processor 514 can interpret relatively sudden detection of movements such as a need for rebalance the exoskeleton 300.

Such a control device 501 has several advantages. The person can control the exoskeleton 300 intuitively. This command is forgotten; the exoskeleton 300 lets itself be used naturally. The exoskeleton 300 and its command reproduce a mechanism of “recovered fall” characteristic of human walking. This also gives an advantage of energetic order: the exoskeleton 300 can usefully use energy produced by a forwards fall in a walking process. This reduces demand for electric power to execute this process.

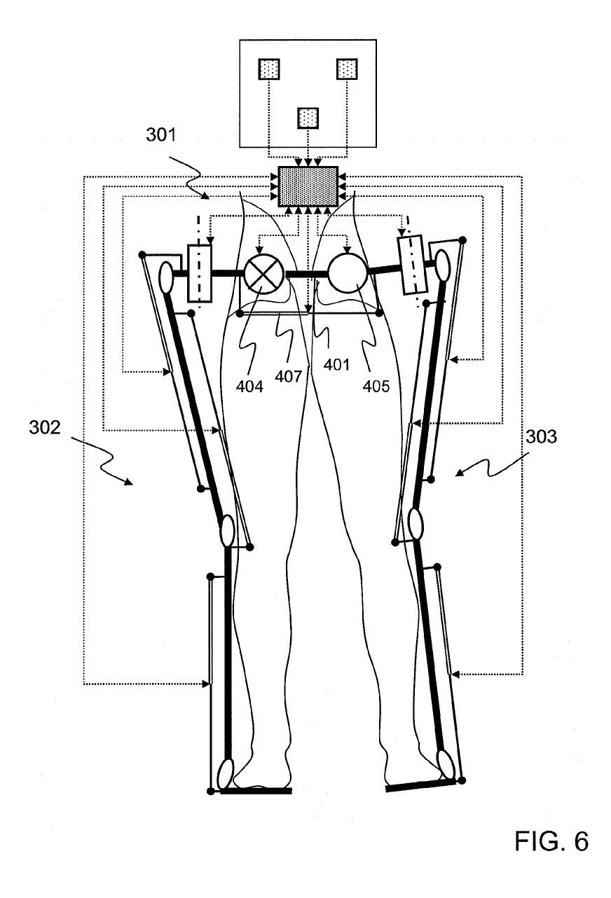

FIG. 6 illustrates the exoskeleton 300 in a state actuated at the pelvic structure 301. The exoskeleton 300 is shown by a schematic diagram similar to that of FIG. 5. In the actuated state illustrated in FIG. 6, the right leg structure 303 is inclined slightly laterally. For this to happen, the right pelvic pivot link 405 is in the unlocked state, while the left pelvic pivot link 404 is in the locked state. The pelvic actuator 407 lengthens under control of the processor 514. The two ends of the pelvic actuator 407 move apart and cause pivoting of the right peripheral pelvic segment 403 relative to the central pelvic segment 401.

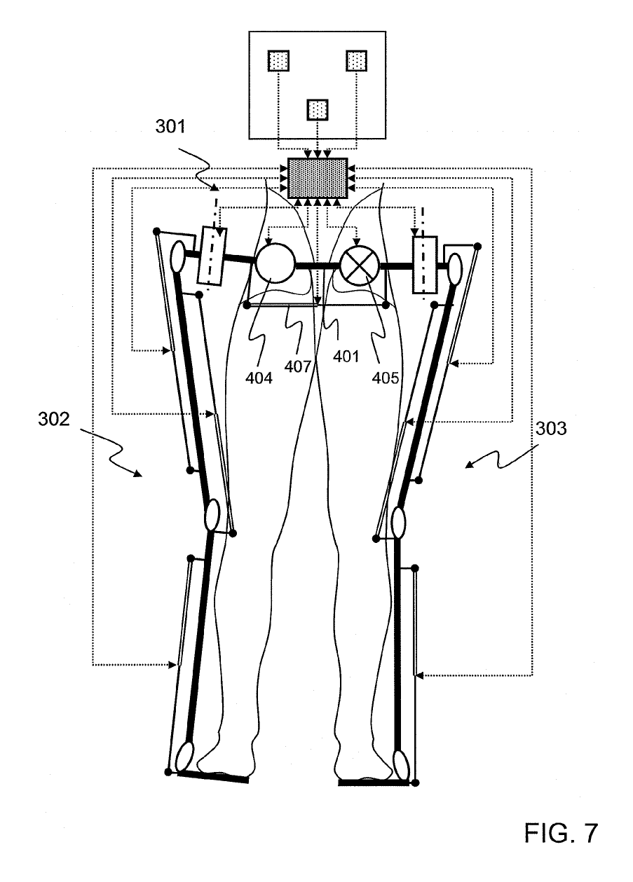

FIG. 7 illustrates the exoskeleton 300 in another state actuated at the pelvic structure 301. The exoskeleton 300 is shown by a schematic diagram similar to those of FIGS. 5 and 6. In the actuated state illustrated in FIG. 7, which can be considered the inverse of that shown in FIG. 6, it is the left leg structure 302 which is inclined slightly laterally. For this to happen, the left pelvic pivot link 404 is in the unlocked state, while the right pelvic pivot link 405 is in the locked state. Here also, the pelvic actuator 407 lengthens under control of the processor 514. The two ends of the pelvic actuator 407 move apart, in this case causing pivoting of the left peripheral pelvic segment 402 relative to the central pelvic segment 401.

The actuated states illustrated in FIGS. 6 and 7 can occur for example during a stabilization process, the person wearing the exoskeleton being in upright position, static position, or during a walking process. These processes can comprise a multitude of movements. Movement at the ankles, especially lateral, orients the top of the body. This movement is typically combined with movements at the pelvic structure 301, which is not necessarily limited to those illustrated in FIGS. 6 and 7.

A stabilization process, or a walking process, typically involves weight transfer of the body of the person wearing the exoskeleton. For example, transfer of the weight of the body to the left or, if needed, to the right, is important to initiate the walking process. The left leg orientation pivot link 410 or, if needed, the right leg orientation pivot link 411 intervenes in this weight transfer. These leg orientation pivot links 410, 411 let the pelvic structure 301 perform a rotation movement relative to a support leg, causing the weight transfer. In transferring the weight of the body to a foot, the other foot is released and can now leave the ground. The weight transfer can also occur in the stabilization process, in reaction to external perturbations, for rebalancing in upright position.

During weight transfer, the exoskeleton 300 can be compelled to perform several types of rotations at the pelvis 110 of the person wearing the exoskeleton. There are three rotations relative to each leg. Rotations according to a vertical axis can be made by means of the left leg orientation pivot link 410 and the right leg orientation pivot link 411. Rotations according to a horizontal axis, perpendicular to the frontal section 115 illustrated in FIGS. 1 and 2, can be done by means of the left pelvic pivot link 404 and the right pelvic pivot link 405. Rotations according to a horizontal axis, perpendicular to the median sagittal section 113 illustrated in FIGS. 1 and 2, can be done by means of the left hip pivot link 312 and the right hip pivot link 313.

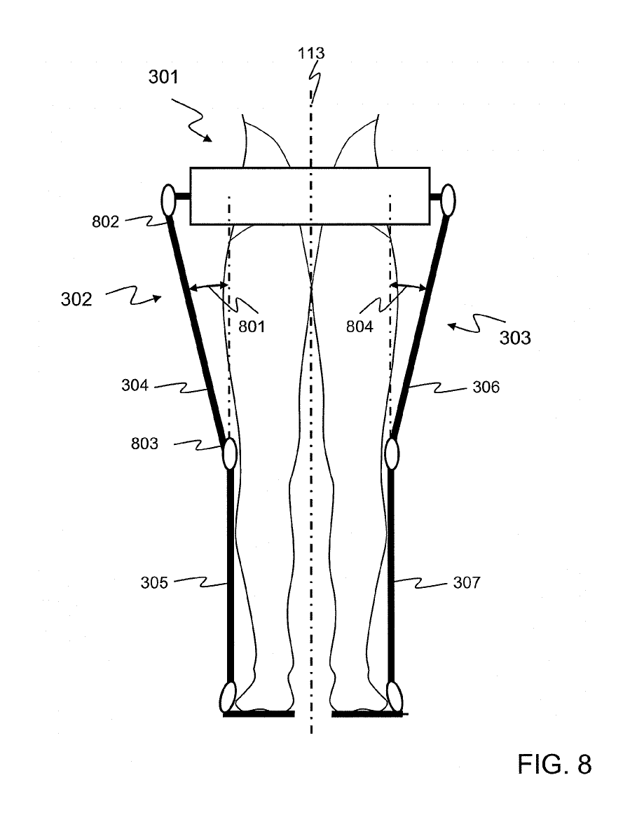

FIG. 8 illustrates more of the exoskeleton 300 in the state of rest. FIG. 8 is a simplified schematic diagram relative to FIG. 5. FIG. 8 illustrates that the upper leg segment 304 of the left leg structure 302 has an inclination 801 relative to the lower leg segment 305 when the exoskeleton 300 is in the state of rest. This inclination 801 is non-zero such that an upper end 802 of the left upper leg segment 304 is further away from the median sagittal section 113 of the person wearing the exoskeleton than a lower end 803. The inclination 801 can be in a range from 0° to 30°, preferably between 0° and 20°. The same remarks apply to the upper leg segment 306 of the right leg structure 303 which has an inclination 804 relative to the lower leg segment 307.

The inclination 801, 804 of the upper leg segments, left 304 and right 306, reproduces a natural inclination. The femurs of a human are typically inclined relative to the vertical when the human is in normal, upright position. By reproducing this inclination, the exoskeleton 300 can perform a weight transfer to a foot more quickly and more energy-efficient, relative to a structure without such inclinations. The inclination reduces displacement of the centre of gravity which is necessary for the latter to be above a support foot.

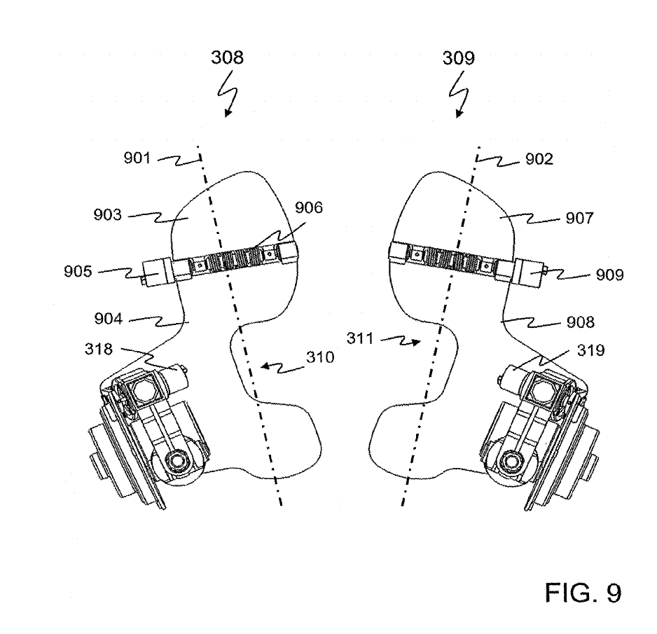

FIG. 9 illustrates in more detail the two foot structures 308, 309 of the exoskeleton 300. FIG. 9 offers a plan view of these two foot structures: the left foot structure 308 and the right foot structure 309. The support plane 310 of the left foot structure 308 has a median longitudinal axis 901 indicated in FIG. 9. Similarly, the support plane 311 of the right foot structure 309 has a median longitudinal axis 902 also indicated in this figure.

Median longitudinal axis 901 (respectively 902) hereinbelow means the axis of the left foot structure 308 (respectively right 309) in the support plane 311 and extending facing the second radius of the foot of the user, when a user places his foot on the left foot structure 308 (respectively right 309).

The support plane 310 of the left foot structure 308 comprises a front platform 903 and a rear platform 904. The median longitudinal axis 901 (respectively 902) therefore extends substantially between the zone corresponding to the heel of the left foot structure 308 (respectively right 309) and the edge 1004 of the front platform 903.

A foot pivot link 905, which extends along a pivot axis 1101, connects the front platform 903 to the rear platform 904. The rear platform 904 is connected to the left ankle pivot link 318. The foot pivot link 905 comprises an elastically deformable member 906, which can be in the form of a torsion spring. This elastically deformable member will be called “torsion spring 906” hereinbelow for reasons of convenience. The torsion spring 906 is capable of storing energy in the form of potential when the front platform 903 is folded relative to the rear platform 904. The support plane 311 of the right foot structure 309 has a similar structure, comprising a front platform 907, a rear platform 908, and a foot pivot link 909.

The foot pivot link 905 constitutes a break of the support plane 310 enabling walking movement which is more fluid, less jerky, more natural and faster relative to a support plane in a single part, without break. During a walking process, a support plane in a single part, without break, should leave the ground, either parallel to this ground or by terminating in a one-off or linear support very difficult to control. The foot pivot link 905 therefore contributes to reproducing more faithfully a walking function which the person wearing the exoskeleton has lost.

This also contributes to greater acceptance of the exoskeleton 300 by the person wearing it, as well as easier and faster accommodation.

Another advantage of the foot pivot link 905 consists on a forward propulsion effect when the rear platform 904 comes off the ground, while the front platform 903 continues to be supported on the ground. The break, formed by the foot pivot link 905, constitutes an axis of rotation for a controlled falling motion. This axis of rotation adds a forwards translation component to the controlled falling motion. This forwards propulsion effect is important in dynamic walking of a human being. The effect lengthens a step in an energetically effective way.

The torsion spring 906 recovers some of the potential energy released during the forward fall. In fact, the torsion spring 906 has a stiffness which is controlled by the forward fall. The torsion spring 906 stores this energy to then recover it when the left foot structure 308 comes off the ground at the end of a step. The description relative to the left foot structure 308 hereinabove applies mutatis mutandis to the right foot structure 309.

It is evident that the median longitudinal axis 901 (respectively 902), the pivot axis 1101 and the median sagittal section form a triangle in which an angle between the pivot axis 1101 and the median longitudinal axis 901 (respectively 902) is preferably between around 60° and 125°, for example between 95° and 105°.

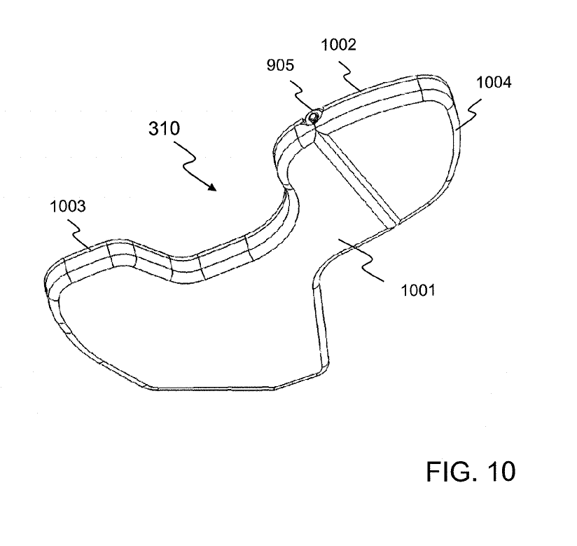

FIG. 10 illustrates other aspects of the left foot structure 308 which also apply to the right foot structure 309. FIG. 10 offers a bottom plan and perspective view of the support plane 310 of this foot structure. The support plane 310 comprises a flexible sole 1001 adapted to contact the ground. This flexible sole 1001 is below a rigid frame which can be in the form of two metal plates 1002, 1003 connected to each other by the foot pivot link 905.

The flexible sole 1001 has a surface adapted to contact the ground. This surface is delimited by rounded edges 1004 clearly shown in FIG. 10. These rounds 1004 of the flexible sole 1001 are located especially at the ends of the foot and on the sides. The rounds 1004 further fluidify forward movement. The rounds 1004 of the sole on its sides let the feet roll slightly on these sides, especially when the pelvic structure 301 produces lateral pulses to balance lateral parasite movement, in upright position when stopped.

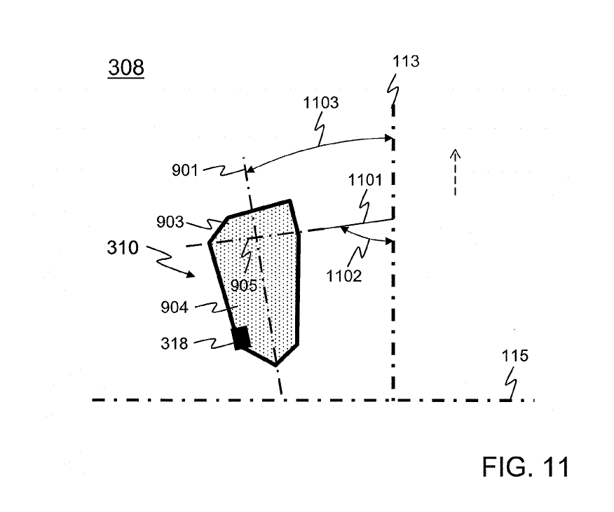

FIG. 11 also illustrates the left foot structure 308. FIG. 11 is a simplified schematic diagram relative to FIG. 9. FIG. 11 illustrates that the pivot axis 1101 of the foot pivot link 905 is located in a quadrant delimited by the median sagittal section 113 of the person wearing the exoskeleton and the frontal section 115 passing through the leg. FIG. 11 further illustrates that the rear platform 904 is closer to the median sagittal section 113 than the front platform 903. The median longitudinal axis 901 of the support plane 310 has a non-zero angle 1103 of between 0° and 45° relative to the median sagittal section 113 when the exoskeleton 300 is in rest position. This range of angles can also have a higher lower limit, for example by one or a few degrees.

The left foot structure 308 of the exoskeleton 300 is therefore oriented to the exterior of an angle which can be 15°, relative to a sagittal direction rather than be oriented straight in the sagittal direction.

In an embodiment, the median longitudinal axis 901 of the support plane 310 has an angle 1103 of between 5° and 35° relative to the median sagittal section 113 when the exoskeleton 300 is in rest position. This angular range optimizes the movement of the exoskeleton during walking. An angle of between 15° and 20° gives particularly satisfying results, to the extent where this range of angles corresponds to the average angle of the foot of a human relative to his median sagittal section when he is walking.

This orientation of the foot structures 308, 309, with an angle 1103 of between 5° and 35° relative to the median sagittal section 113 when the exoskeleton 300 is in rest position, for example between 15 and 20°, produces an exoskeleton whereof the structure and movement are closer to human biomechanics than an exoskeleton whereof the median longitudinal axis is parallel to the median sagittal section (corresponding to the case where the angle 1103 is zero). Such an exoskeleton is consequently more comfortable for the user and more reliably reproduces the human walking.

This orientation to the exterior therefore best reproduces human walking since human feet are also oriented in this way. Also, during a step, during a thrust phase, this orientation of the foot best directs the thrust by introducing a latero-medial component, which propels the body of the person wearing the exoskeleton from one support foot to a receiving foot.

This angular orientation of the foot structures 308, 309 further enlarges the lifting polygon of the foot structures 308, 309 relative to the ground (i.e., their support surface which is in contact with the ground). In effect, in the exoskeleton of the invention (as for a human being), the rear platforms 902 of the foot structures 308, 309 (and the ankles and tibial segments) are closer than the hips for reducing the energy necessary during walking of the exoskeleton, which tends to reduce the lifting polygon and therefore goes against good stability of a user when the latter is upright, both feet on the ground. The fact of orienting the foot structures 308, 309 to the exterior (forming a non-zero angle 1103) enlarges the surface of this lifting polygon and therefore improves the stability of the user when the latter is upright with feet on the ground.

In an embodiment, the foot pivot link 905 can have a pivot axis 1101 defining a right triangle in the quadrant delimited by the median sagittal section 113 of the person wearing the exoskeleton and the frontal section 115 passing through the leg. The pivot axis 1101 can especially have an angle 1102 in a range from 45° to 90° relative to the median sagittal section 113, preferably of between 50° and 85°, for example of the order of 60 to 65°.

In the event where the median longitudinal axis forms an angle 1103 of between 5° and 35° with the median sagittal section when the exoskeleton 300 is in rest position, an angle 1102 of the pivot axis 1101 of between 60° and 65° relative to the sagittal section corresponds substantially to the average angle formed by the first and the fifth metatarsal articulation.

Such orientation of the pivot axis 1101 of the foot pivot link 905 adapts the foot structure 308, 309 of the exoskeleton to the structure of the human foot given the orientation of the break of the foot at the metatarsal articulations, which boosts the comfort and security of the user. It also executes transmission of propulsion forces and ensures the stability of the user and of the exoskeleton.

Also, during walking movement, orientation of the pivot axis 1101 of the foot pivot link 905 of between 50° and 85° ensures good spatial positioning of the ankle, the tibia and the knee when the rear platform pivots about the pivot link 905 (i.e., when the foot structure 308, 309 is “broken”).

FIG. 11 illustrates that the foot pivot link 905, which forms the break of the left foot structure 308, is oriented so as to be substantially perpendicular to the sagittal section, i.e., substantially perpendicular to the axis of walking. In this example, the foot pivot link 905 is therefore not perpendicular to the median longitudinal axis 901 of the support plane 310 of the left foot structure 308. This orientation of the foot pivot link 905 enables tipping of the exoskeleton 300, and the person wearing it, forwards in the direction of walking. The left ankle pivot link 318 also plays a role in this tipping having an anterior-medial orientation, which will be described hereinbelow.

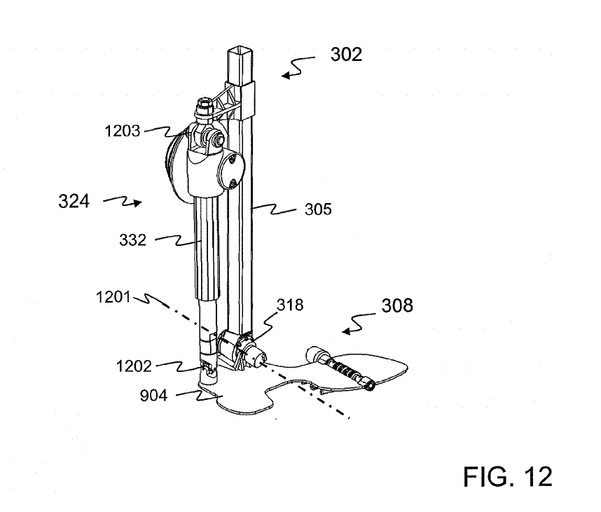

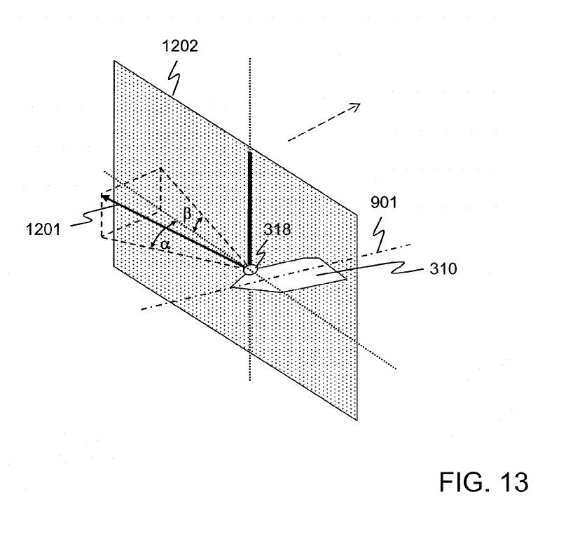

FIG. 12 illustrates a left lower part of the exoskeleton 300 comprising the left ankle pivot link 318. FIG. 12 offers a perspective view of the left lower part of the exoskeleton 300. FIG. 12 illustrates that the left ankle pivot link 318 has a pivot axis 1201 having a particular orientation. The pivot axis 1201 can be qualified as oblique since it is not contained in any reference plane: frontal, sagittal or horizontal. But the pivot axis 1201 is oriented as follows: latero-medial, postero-anterior, dorso-plantar. The pivot axis 1201 however comprises a main component perpendicular to the median longitudinal axis 901 of the support plane 310 of the left foot structure 308, illustrated in FIG. 9.

FIG. 12 also illustrates in more detail the left ankle actuation device 324 associated with the left ankle pivot link 318. The left ankle actuator 332 of this device is disposed between the left leg structure 302, whereof FIG. 12 illustrates the lower leg segment 305, and the left foot structure 308. The left ankle actuation device 324 can cause pivoting of the left foot structure 308 relative to the left leg structure 302 along the pivot axis 1201 of the left ankle pivot link 318.

The left ankle actuation device 324 comprises a Cardan joint 1202 and a ball-joint link 1203 in addition to the left ankle actuator 332. The Cardan joint 1202 connects an end of the left ankle actuator 332 to the left foot structure 308, more precisely to the rear platform 904 of the latter. The ball-joint link 1203 connects another end of the left ankle actuator 332 to the lower leg segment 305 at a connection point far away from the left foot structure 308. The left ankle actuator 332 can be in the form of a jack, as mentioned hereinabove. The left ankle actuator 332 is located posteriorly on the lower leg segment 305 and is related as it were to a soleus muscle.

As a variant, the left ankle actuation device 324 can also comprise two Cardan joints in addition to the left ankle actuator, in the event where the left ankle actuator comprises a linear actuator without anti-rotation (such as a jack whereof the rod is rotationally movable about its axis). In this case, a first of the Cardan joints can connect an end of the left ankle actuator to the left foot structure 308, more precisely to the rear platform 904 of the latter, while the second Cardan joint connects another end of the left ankle actuator 332 to the lower leg segment 305 at a connection point far away from the left foot structure 308.

The left ankle actuation device 324, the left ankle pivot link 318, the lower leg segment 305, and the left foot structure 308, form a kinematic loop. This kinematic loop can make movements in three dimensions, which therefore do not remain in a reference plane. During these movements the left ankle actuator 332 remains along the lower leg segment 305 of the exoskeleton 300. This gives low bulk to this assembly and avoids interference between the left ankle actuator 332 and the left leg 101 of the person wearing the exoskeleton 300.

FIG. 13 schematically illustrates the pivot axis 1201 of the left ankle pivot link 318. FIG. 13 shows a schematic diagram of the pivot axis 1201. The support plane 310 of the left foot structure 308 is shown schematically in this figure. A plane 1202 perpendicular to the median longitudinal axis 901 of the support plane 310 is also shown. An arrow represents the direction of walking.

The pivot axis 1201 of the left ankle pivot link 318 has a non-zero angle 13 in a range from 0° to 30° relative to the support plane 310 of the foot structure, preferably between 5° and 30°. The pivot axis 1201 has a non-zero angle a in a range from 0° to 45° relative to a plane 1202 perpendicular to the median longitudinal axis 901 of the support plane 310. One and the other range of angles can also have a higher lower limit, for example, of one or a few degrees. For example, the angle α can be of the order of 3° (near 1 degree), for an angle β of the order of 16° (to within 1 degree), so as to optimize the position of the pivot axis 1201 of the ankle pivot link and beat approximate human movement, which also reduces energy consumption.

By having this pivot axis 1201, which is oblique, the left ankle pivot link 318 lets the exoskeleton 300 produce movements which approximate natural movements at a human ankle, especially movements which are the more frequent and important. A human ankle, and a back foot, constitute biomechanics of relatively substantial complexity. These biomechanics have several degrees of liberty, especially in tibio-tarsal, subtalar and Chopart articulations. These degrees of liberty play important roles in processes of locomotion and balancing of a human being.

The particular orientation of the pivot axis 1201 adds an offset in a medio-lateral direction at an inclination of the left leg structure 302 in a postero-anterior direction, and vice versa. More specifically, an inclination of the left leg structure 302 in a “positive” forward direction is accompanied by relatively slight lateral offset of this structure relative to the median longitudinal axis 901 of the left foot structure 308. This offset is therefore oriented to the exterior. Inversely, inclination of the left leg structure 302 in a “negative” direction to the rear is accompanied by an offset to the interior relative to the median longitudinal axis of the left foot structure 308. This offset which is oriented to the interior can be greater than the offset oriented to the exterior.

The offset in the medio-lateral direction, by way of the orientation particular of the pivot axis 1201 of the left ankle pivot link 318, enables transfer of the weight of the body to a support foot. This is linked to movements of the pelvic structure 301, described hereinabove, which can also contribute to this weight transfer. The weight transfer occurs when a step is initiated, but also during ongoing walking, as well as in stabilization in upright position. Also, during walking, during propulsion there is a phase where the left ankle pivot link 318 is in plantar flexion and where the foot structure is folded in two at the foot pivot link 905. By way of the particular orientation of the pivot axis 1201, lateral translation of the centre of gravity can be made from one foot to the other.

The left ankle pivot link 318 therefore effectively substitutes the relatively complex biomechanics of the human ankle, and of the human back foot. The left ankle pivot link 318 constitutes a relatively simple, non-bulky and reliable system. However, this system enables movements approximating substantial movements which the biomechanics perform during a walking process, or during a stabilization process. The description of the left ankle pivot link 318 hereinabove applies mutatis mutandis to the right ankle pivot link 319.

In reference again to FIG. 5, the processor 514 of the exoskeleton 300 can be programmed to effect several control modes. That is, the processor 514 can comprise a program, i.e., a set of executable instructions, defining several control modes. For example, a stabilization control mode can be provided to keep the person wearing the exoskeleton in a rest position. A walking control mode can be provided to assist the person wearing the exoskeleton to walk. Other control modes can be provided for example to climb steps, descend steps, sit down on a chair, and stand up from a chair. In all these control modes, the processor 514 controls at least part of the actuators described hereinabove, causing movements of the exoskeleton 300.

The program can also let the processor 514 select a control mode, and carry it out, as a function of detection signals coming from the detector 510 and, more specifically, from the inertial sensors 511, 512, 513. The exoskeleton 300 can be fitted with other sensors which can transmit useful information to the processor 514 to execute the selected control mode. For example, one or more sensors capable of detecting obstacles can be provided on the left foot structure 308 and on the right foot structure 309. These sensors, which can be optical, are capable of detecting for example a step or a staircase. Such a sensor could also detect a distance relative to an obstacle and communicate this information to the processor 514.

Selection of a control mode and its execution can be based on a dynamic parameter of the torso 109 of the person, illustrated in FIG. 1, wearing the exoskeleton. The inertial sensors can detect such a parameter and communicate information relative to the parameter in question to the processor 514. In this way, the processor 514 can select a control mode and execute it from a displacement speed of the torso 109, or from acceleration of the torso 109, such as measured. In another embodiment, the processor 514 can determine a position of a centre of gravity from detection signals coming from the inertial sensors. The processor 514 selects a control mode and executes it from this centre of gravity.

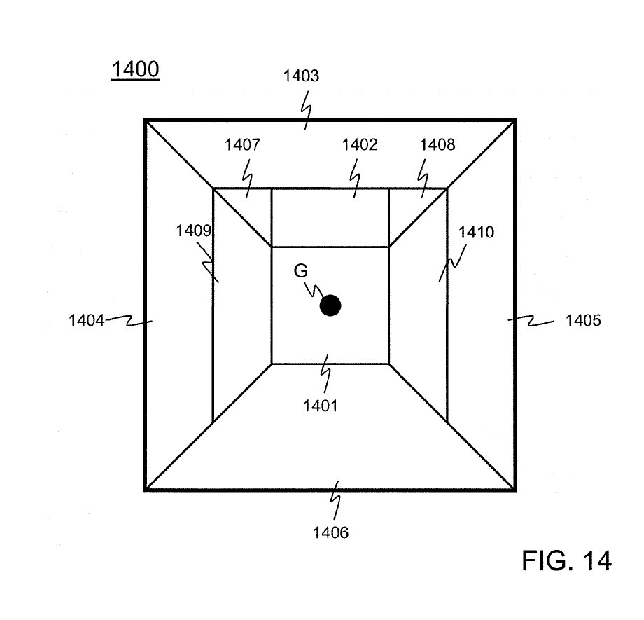

FIG. 14 illustrates a projection plane 1400 for control mode selection.

The processor 514 projects onto this plane 1400 the centre of gravity G as set from information coming from the detector 510. The projection plane 1400 comprises different zones 1401 to 1410. Different control modes are respectively associated with the different zones 1401 to 1410. The processor 514 applies a control mode associated with a zone containing the centre of gravity G.

The projection plane 1400 comprises a central zone 1401. This central zone 1401 is associated with a static stabilization mode. In this mode, the processor 514 stabilizes the exoskeleton 300 statically by keeping the two foot structures 308, 309 on the ground. The processor 514 responds to perturbation at the torso 109 by forcing the exoskeleton 300 to make one or more appropriate, compensatory movements. For example, if the person wearing the exoskeleton leans slightly backwards, the processor 514 could cause flexing of the exoskeleton 300 at the knee pivot links 316, 317 so as to direct the centre of gravity G forwards to the centre of a lifting polygon.

The projection plane 1400 comprises a walking zone 1402 associated with a normal walking mode. To trigger the normal walking mode, the person wearing the exoskeleton must lean forwards enough for the centre of gravity G to therefore exit from the central zone 1401 and enter the normal walking zone 1402. The exoskeleton 300 starts to walk forwards and stops if the person stands upright.

The plane also comprises emergency stabilization zones. If the user is leaning too far forwards, the centre of gravity enters an anterior emergency stabilization zone 1403. The processor 514 directs the exoskeleton 300 to take a big step forwards to stabilize. A left lateral emergency stabilization zone 1404 is provided for imbalance on a left side. The processor 514 directs the exoskeleton 300 to take a lateral step on its left side. Similarly, a right lateral emergency stabilization zone 1405 is provided for imbalance on a right side. The processor 514 directs the exoskeleton 300 to take a lateral step on its right side. Finally, a posterior emergency stabilization zone 1406 is provided for imbalance to the rear. The processor 514 directs the exoskeleton 300 to take a backward step to regain its balance.

The plane also comprises zones for turning: a zone for turning left 1407 and a zone for turning right 1408, especially during a walking process. The plane can also comprise zones for moving away: a zone for moving away to the left 1409, and a zone for moving away to the right 1410.

### NOTES

The detailed description which has just been made in reference to the drawings is only one illustration of several embodiments of the invention. The invention can be executed in many different ways. To illustrate this, some alternatives are outlined in summary.

The invention can be applied in many types of exoskeleton. For example, the invention can be applied in an exoskeleton which comprises a single leg structure only, with a single foot structure.

An exoskeleton according to the invention can comprise a lower or greater number of actuators than the number of actuators in the embodiments described in detail in reference to the drawings. For example, other embodiments can be obtained by omitting an actuation device associated with a pivot link. That is, a pivot link must not necessarily be actuated, but can be free. Also, other embodiments can be obtained by omitting or adding pivot links, as well as other elements. An alternative embodiment can be simpler or more elaborate than those described, by way of example, hereinabove.

A pelvic structure according to the invention can be made in different ways. The detailed description presents an example in which the pelvic structure 301 comprises only a single actuator 407 with blocking devices 408, 409. In another embodiment, a pelvic structure can comprise two actuators: an actuator for a left pelvic pivot link, and another actuator for a right pelvic pivot link. Such a pelvic structure needs no blocking device.

Control of an exoskeleton according to the invention can be realized in many different ways. For example, in the event where control involves determination of a centre of gravity, the control can vary as a function of a position of the centre of gravity in a three-dimensional space, a volume. A command can also be based on a speed of displacement of the centre of gravity, or acceleration.

The term “processor” must be interpreted broadly. This term encompasses any type of device which can produce one or more output signals from one or more input signals, especially to execute a control function. The term “pivot link” can extend such as defined in solids mechanics.

The preceding remarks show that the detailed description in reference to the figures illustrates the invention more than limiting it. The references signs have no limiting character. The verbs “comprise” and “include” do not exclude the presence of other elements or other steps than those listed in the claims. The word “a” or “an” preceding an element or a step does not exclude the presence of a plurality of such elements or such steps.

1. An exoskeleton (300) comprising:
a foot structure (308) comprising a support plane (310) on which a foot (107) of a leg (101) of a person wearing the exoskeleton can be supported when the foot lays flat, the support plane comprising:
a front platform (903) and a rear platform (904), and a foot pivot link (905) connecting the front platform to the rear platform, the exoskeleton being characterized in that the foot pivot link (308) is located in a quadrant delimited by a median sagittal section (113) of the person wearing the exoskeleton and a frontal section (115) passing through a leg (101), and in that the rear platform (904) is closer to the median sagittal section (113) than the front platform (903), such that a median longitudinal axis (901) of the support plane (310) has a non-zero angle (1103) of between 0° and 45° relative to the median sagittal section when the exoskeleton is in rest position.

2. The exoskeleton according to claim 1, wherein the angle (1103) of the median longitudinal axis (901) of the support plane (310) with the median sagittal section is between 5° and 35°, preferably between 15° and 20°.

3. The exoskeleton according to any one of claims 1 and 2, wherein the foot pivot link (905) comprises an elastically deformable member (906) disposed to store energy when the front platform (903) is folded relative to the rear platform (904).

4. The exoskeleton according to any one of claims 1 to 3, wherein the support plane (310) of the foot structure (308) comprises a flexible sole (1001) adapted to contact the ground.

5. The exoskeleton according to any one of claims 1 to 4, wherein the support plane of the foot structure (310) comprises a surface adapted to contact the ground whereof at least one part is delimited by a rounded edge (1004).

6. The exoskeleton according to any one of claims 1 to 5, the foot pivot link having a pivot axis (1101) defining a right triangle in the quadrant and having an angle (1102) in a range from 45° to 90° relative to the median sagittal section.

7. The exoskeleton according to claim 6, wherein the angle (1102) of the pivot axis (1101) is in a range from 50° to 85° relative to the median sagittal section, preferably between 60° and 65°.

8. The exoskeleton according to any one of claims 1 to 7, comprising:
a leg structure (302) disposed to be next to a leg (101) of the person wearing the exoskeleton,
an ankle pivot link (318) connecting the foot structure (308) to the leg structure, the ankle pivot link having a pivot axis (1201) having:
a non-zero angle (β) in a range from 0° to 30° relative to the support plane (310) of the foot structure, and
a non-zero angle (α) in a range from 0° to 45° relative to a plane (1202) perpendicular to the median longitudinal axis of the support plane.

9. The exoskeleton according to claim 8, wherein the pivot axis (1201) has an angle (β) in a range from 5° to 30° relative to the support plane (310) of the foot structure.

10. The exoskeleton according to any one of claim 7 or 8, wherein the pivot axis (1201) has an angle (β) of 16° relative to the support plane (310) of the foot structure and an angle (α) of 3° relative to the plane (1202) perpendicular to the median longitudinal axis of the support plane.

11. The exoskeleton according to any one of claims 7 to 9, comprising an actuation device disposed between the leg structure (302) and the foot structure (308) to cause pivoting of the foot structure relative to the leg structure along the pivot axis (1201) of the ankle pivot link (318).

12. The exoskeleton according to claim 11, wherein the actuation device comprises:
a Cardan joint (1202), a ball-joint link (1203), and an actuator (332, 333) disposed between the Cardan joint and the ball-joint link, typically a linear actuator, or
two Cardan joints and a linear actuator without anti-rotation disposed between the Cardan joints, typically a linear actuator.

13. The exoskeleton according to any one of claims 7 to 12, wherein the leg structure (302) comprises:
an upper leg segment (304) disposed to be next to an upper part of the leg (101) located above a knee (103) of the person wearing the exoskeleton,
a lower leg segment (305) disposed to be next to a lower part of the leg located below the knee, and
a knee pivot link (316) connecting the lower leg segment to the upper leg segment,
the upper leg segment having a non-zero inclination (801) in a range from 0° to 30° relative to the lower leg segment when the exoskeleton is in rest position, preferably from 0° to 20°, such that an upper end (802) of the upper leg segment is further away from a median sagittal section (113) of the person wearing the exoskeleton than a lower end (803).

14. The exoskeleton according to any one of claims 8 to 13, comprising:
a pelvic structure (301) disposed to be attached to the pelvis (110) of the person wearing the exoskeleton,
a leg orientation pivot link (410) disposed between the pelvic structure and the leg structure (302), the leg orientation pivot link having a vertical pivot axis when the exoskeleton is in rest position.

15. The exoskeleton according to any one of claims 1 to 14, comprising a control device (501) capable of controlling at least one actuator (407, 412, 413, 326, 329-333) included in the exoskeleton.

16. The exoskeleton according to claim 15, wherein the control device (501) comprises:
a detector (510) capable of detecting at least one dynamic parameter of at least one part of the torso (109) of the person wearing the exoskeleton, and
a processor (514) capable of applying a control signal to an actuator (407, 412, 413, 326, 329-333) as a function of a detected parameter.

17. The exoskeleton according to claim 16, wherein the detector (510) comprises at least one inertial sensor (511-513).

18. The exoskeleton according to any one of claims 16 and 17, wherein the processor (514) is configured to:
control at least one actuator (407, 412, 413, 326, 329-333) to keep the person wearing the exoskeleton in a rest position, and
control at least one actuator to assist the person wearing the exoskeleton to walk.

19. The exoskeleton according to claim 18, wherein the processor (514) is configured to determine a position of a centre of gravity (G) of at least one part of the body of the person wearing the exoskeleton and control the actuator(s) (407, 412, 413, 326, 329-333) to assist the person wearing the exoskeleton to walk as a function of the position of the centre of gravity.

20. The method according to claim 19, wherein the processor is configured to control the actuator(s) (407, 412, 413, 326, 329-333) to keep the person wearing the exoskeleton in a rest position or assist the person wearing the exoskeleton to walk as a function of the zone (1401-1410) in a plane (1400) containing a projection of the centre of gravity (G).
